(19) United States
(12) Patent Application Publication
(10) Pub. No.: US 2007/0099634 A1
(43) Pub. Date: May 3, 2007

(54) Mesh network that provides location information

(75) Inventors: Amalavoyal Chari, Sunnyvale, CA (US); Devabhaktuni Srikrishna, Sunnyvale, CA (US)

Correspondence Address: Tropos Networks, PO Box 641867, San Jose, CA, 95164-1867, US

(73) Assignee: Tropos Networks, Inc.

(21) Appl. No.: 11/265,345

(22) Filed: Nov. 2, 2005

(51) Int. Cl. H04Q 7/20

(52) U.S. Cl. 455/456.3

(57) ABSTRACT

An apparatus and method of providing location information in a wireless mesh access network is disclosed. The wireless mesh network includes mesh access nodes, and provides connectivity between a client device and a destination server. The method includes providing each access nodes with its own location information. At least one of the access nodes receives an HTTP Request from the client device to a destination server. The access node, functions as an intercepting proxy and proxies the HTTP Request to the destination server. The access node further inserts a location tag carrying the location information into the proxied HTTP Request that is sent to the destination server.

### FIELD OF THE INVENTION

The invention relates generally to wireless communications. More particularly, the invention relates to a method and apparatus of a mesh network that provides location information.

### BACKGROUND OF THE INVENTION

Packet networking is a form of data communication in which data packets are routed from a source device to a destination device. Packets can be networked directly between a source node and a destination node, or the packets can be relayed through a number of intermediate nodes.

A wireless network can include a wireless device being connected to a network through a base station that is wired to the network. The wireless device can transmit data packets that are received by the base station and then routed through the network. The wireless network can include many base stations that are each wired to the network. Other wireless networks include wireless mesh networks.

Internet advertising is continually growing at a rapid pace. One goal of internet advertising is to specifically target the advertising to particular clients. The client's location is an ideal piece of information that can be used for targeted advertising. Knowing the client's location allows for advertising of goods and services that are located physically close to the client, and therefore, more likely to be purchased by the client. Additionally, location based advertising is convenient to the client.

GPS (global positioning systems) which can provide client locations are presently being deployed in cell phones. However, laptops and personal computers are not presently utilizing GPS technology.

It is desirable to have a wireless mesh network that provides client location information to network servers or, upon demand, to client devices.

### SUMMARY OF THE INVENTION

An embodiment of the invention includes a method of providing location information in a wireless mesh access network. The wireless mesh network includes mesh access nodes, and provides connectivity between a client device and a destination server. The method includes providing each access nodes with its own location information. At least one of the access nodes receives an HTTP Request from the client device to a destination server. The access node, functions as an intercepting proxy and proxies the HTTP Request to the destination server. The access node further inserts a location tag carrying the location information into the proxied HTTP Request that is sent to the destination server.

Another embodiment of the invention also includes a method of providing location information in a wireless mesh access network. The wireless mesh network includes mesh access nodes, and provides connectivity between a client device and a destination server. The method includes each access node having its own location information. At least one of the access nodes receives a request from a client device, and the access node responds to the request by providing the location information of the access node to the client device.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 shows a wireless network that includes access nodes that provide client device location information.

FIG. 2 is a flow chart showing steps of a method in which an access node provides client location information.

FIG. 3 shows wireless mesh network that includes access nodes that provide client device location information.

FIG. 4 is a flow chart showing a method of how an access node inserts location information into data packets of a client device.

FIG. 5 is a flow chart showing steps of a method in which an access node provides location information to client devices.

FIG. 6 is a flow chart including steps of a method of an access node responding to a client device request for location information.

### DETAILED DESCRIPTION

As shown in the drawings for purposes of illustration, the invention is embodied in an apparatus and method for a mesh network that provides location information. The location information can be used by web-based servers to target advertising to clients connected to the mesh network.

Wireless mesh network can be used to provide access to wireless or wired client devices. Mesh networks have several advantages over other wireless access networks including resilience to failures, fewer backhaul requirements, ease of deployment, ability to self-configure and self-heal, etc. Wireless mesh networks are deployed in indoor LAN environments as well as in outdoor metro-area deployments covering many tens or hundreds of square miles.

It is often desirable to a network operator or to an application provider to have information related to the location of client devices within the network. The operator or application provider can use the client device location information to deliver more targeted content to the client device or to provide more accurate (location-specific) search results to the client device. For example, major search engines such as Google and Yahoo are able to offer search results to web-browser-based clients based on location, allowing the user to search for products or services around a specific location.

One way to obtain the client device location information is through user input. For example, in a Google search, the user can input his zip code or street address in addition to the search terms, thereby allowing the search engine to determine and deliver local search results. A drawback of this approach is that it requires the user to manually input his location and is therefore inconvenient. In some cases, the precise location may not be known to the end-user on the client device. In some cases, the end-user's location may be changing because the user is mobile. In some cases, there may not be an end-user on the client device as is the case with automated meter reading devices, for example. In some cases, there may not be data entry capability on the mobile device, as might be the case on some phone handsets, for example. In the case of some applications such as localized content delivery, there may not be an input form to allow the end-user to input location information. For these reasons, it is advantageous to be able to infer the location of the end-user without requiring the intervention of the end-user.

GPS (Global Positioning System) is an established technology that can be used to accurately obtain location information through receiving and triangulating signals from GPS satellites. One drawback of this approach is that it requires a GPS receiver to be embedded in the-client device. This requirement imposes additional cost on the client device. Furthermore, since many devices are not so-equipped today, GPS cannot be used to locate these devices. For these reasons, it is advantageous to have a method to locate an end-user or device without requiring the presence of GPS or other location capability on the end-user device.

Other technologies for determining the location of client devices include network-based location systems employing TDOA (Time Difference Of Arrival), etc. as well as network-assisted or network-based location systems. The present invention relates to a means of conveying location information to web-based servers or to clients, no matter how the location information is generated or determined.

Wireless mesh networks are deployed in several cities and counties in the US and abroad. Many of these wireless mesh networks are deployed using unlicensed spectrum in the 2.4 GHz and 5 GHz bands. In these unlicensed frequency bands, with FCC regulations on maximum transmit power, the cell-sizes are small—from hundreds to a few thousand feet. In such deployments, anywhere from 10 to 30 wireless mesh access nodes are deployed per square mile to achieve the desired coverage footprint. At such node densities, the average distance between mesh access nodes is between 0.25 and 0.5 miles. Because of the small cell sizes in these networks, the location of the access node is a good approximation to the location of a client device accessing the network through that access node. That is, the access devices are “in the neighborhood” of the client devices.

For emergency services (such as 911), it is necessary to have very precise location information, down to a few tens of feet. For many applications of location-based services, however, it suffices to be able to narrow down the location of the client device to a general neighborhood which may be as much as a quarter to half a mile. For these applications, the location of the access node to which the client device is attached (which is typically within a few hundred to a few thousand feet of the location of the client device) is a good proxy for the location of the client device.

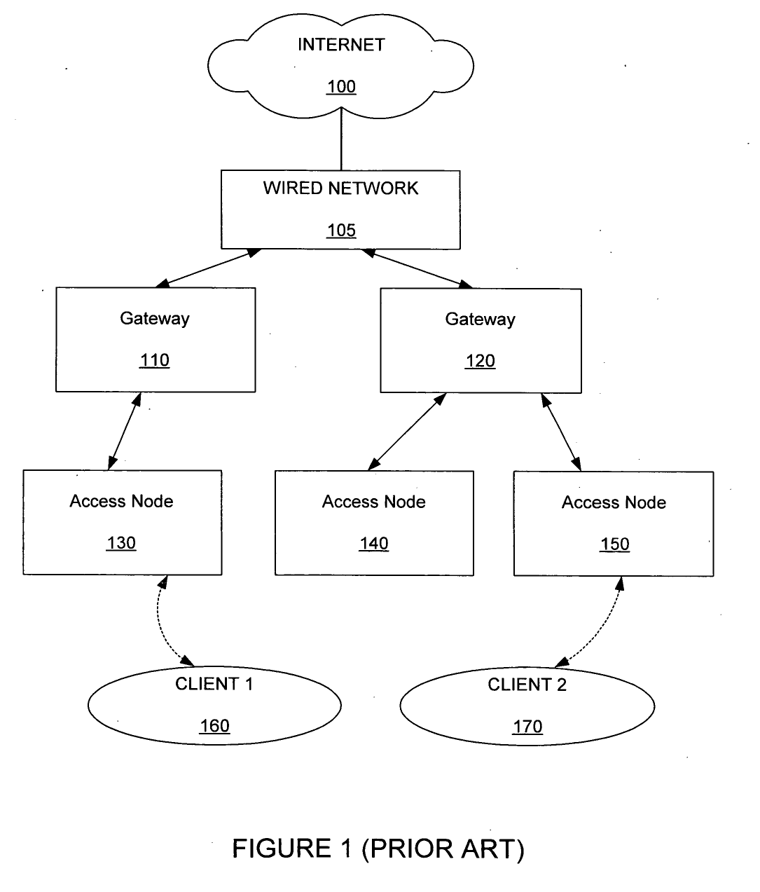

FIG. 1 shows a wireless network that includes access nodes that provide client device location information. The network includes access nodes 130, 140, 150 that client device 160, 170 can use to obtain access to a wired network, such as wired network 105 that is connected to the internet 100. Here, all of the access nodes 130, 140, 150 are wire connected to gateways 110, 120. Knowledge of the locations of the access nodes 130, 140, 150 can be used to obtain an approximate location of the client devices 160, 170 when the client devices 160, 170 are connected to one of the access nodes 130, 140, 150.

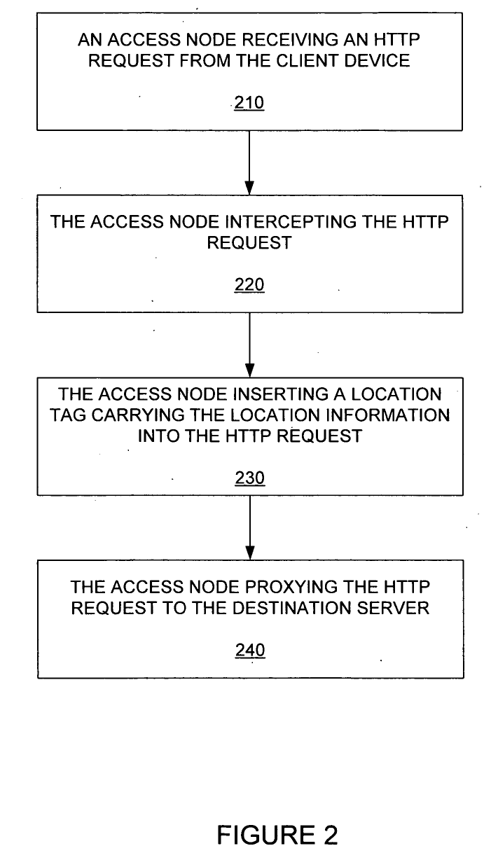

FIG. 2 is a flow chart showing steps of a method in which an access node provides client location information. The wireless mesh network includes one or more mesh access nodes that have access to their location information, and provide connectivity between a client device and a destination server. A first step 210 includes an access node receiving an HTTP request from the client device. A second step 220 includes the access node intercepting the HTTP request. A third step 230 includes the access node inserting a location tag carrying the location information into the HTTP request. A fourth step 240 includes the access node proxying the HTTP request to the destination server. An embodiment can include the first step 210 and the second step 220 being combined. More specifically, these steps can be replaced with an access node intercepting an HTTP request from the client device. The access node can insert more than a single location tag. That is, the access node can insert at least one location tag carrying the location information into the HTTP request.

Access Node Location Information

In wireless mesh networks deployed today, the mesh access nodes are typically mounted on streetlights, traffic lights, utility poles and the like. The location of each access node is recorded when the node is attached to the mounting asset and the network operator typically maintains a database of the node locations in an asset management database. In addition, the access nodes can be configured to have their location information (latitude, longitude, street address, zip code, etc.)—this can be helpful in troubleshooting customer connectivity issues and in providing customer support. Since the access nodes are stationary (mounted to streetlights), their location does not change over time and the configuration settings for node locations are fixed.

There may also be mobile mesh access nodes that are mounted inside vehicles such as police squad cars. Such mobile mesh access nodes may have integrated GPS receivers to dynamically obtain location information as the vehicle moves around. Clearly, GPS receivers can be located in fixed access nodes as well.

Data Packets

Several protocols exist for transferring data in packet form from a source to a destination across a network. HTTP (Hyper Text Transfer Protocol) is one common protocol for data transfer. FTP (File Transfer Protocol) is another. Other examples of protocols for data transfer will be obvious to those skilled in the art.

In the HTTP protocol, a client application (such as a web browser on a client device) is used to generate an HTTP Request for a URL (Uniform Resource Locator). The URL identifies the specific resource on an HTTP server that the client application is trying to access. An example URL is http://www.tropos.com/whitepapers/metromesh.pdf. Uniform Resource Identifiers (URIs, also known as URLs) are short strings that identify resources in the web: documents, images, downloadable files, services, electronic mailboxes, and other resources. They make resources available under a variety of naming schemes and access methods such as HTTP, FTP, and Internet mail addressable in the same simple way. The HTTP protocol commonly operates over a transport layer protocol such as TCP (Transmission Control Protocol).

The HTTP protocol can be used for many applications including performing searches on the web. In a web search application, the end-user enters a search term and the browser sends an HTTP request containing the URL of the search engine along with the search term(s). The search engine returns a response containing the search results formatted as an HTML document. It is desirable, in this context, for the search engine to obtain knowledge of the location of the end-user in order to be able to deliver search results that are relevant to the end-user location. For instance, a user searching for “auto mechanics” might find listings of mechanics in his immediate neighborhood to be more relevant and useful.

The URL for the search query might take the form http://www.search.com/guery?keyword=auto+mechanic, in the example cited above. Other ways of formatting search query URLs are obvious to one skilled in the art.

An interception proxy (as defined in RFC 3040) receives inbound traffic flows through the process of traffic redirection. Such proxies are deployed by network administrators to facilitate or require the use of appropriate services offered by the proxy. The use of interception proxies requires zero configuration of the end-user's browser which acts as though communicating directly with a destination server.

Location Tags

One mechanism to provide the search engine with the end-user location is by the user's web browser modifying the URL of the search query input by the end-user to include tags that indicate the location of the user. However, this is not desirable because it requires changes to the browser application and because the end-user's location information may not be available to the browser application. Another approach, which is included within embodiments of the invention, is to proxy the client's search query by intercepting the HTTP session at the access node and to send a separate query to the search engine HTTP server containing the user's search terms in addition to tags containing the location of the access node. This translation can be achieved by implementing an interception proxy as defined earlier, but other means of embedding location tags into HTTP requests are apparent to those skilled in the art. Since the user connecting to the access node is presumed to be in close proximity to the. access node, the location of the access node is a good approximation to the location of the client device (and the end-user).

The Common Gateway Interface (CGI) is a standard for interfacing external applications with information servers, such as HTTP or Web servers. A plain HTML document that the Web browser retrieves is static, which means it exists in a constant state: a text file that doesn't change. A CGI program, on the other hand, is executed in real-time, so that it can output dynamic information. One exemplary embodiment includes the location tag being embedded in the http request through a CGI variable appended to the set of CGI variables entered through an HTML form.

As an example, the interception proxy on the access node receives and terminates an HTTP request from the client device for the URL http://search.provider.com/?keyword=auto+mechanic and proxy generates a new HTTP request for the URL http://search.provider.com/?keyword=auto+mechanic+zip=94085. If the search engine is capable of interpreting the location tag “zip” and generating locally relevant results, the response from the search engine contains an HTML document containing search results for auto mechanics in the 94085 zip code. The interception proxy on the access node receives this HTML document and conveys it to the client device.

In one exemplary embodiment, the location tag is encrypted using public key cryptography. In this embodiment, the location tag is encrypted using the public key of the search, application or content provider. Only the authorized recipient of this location information (the search, application or content provider, in this example) has the corresponding private key required to decrypt the location tag and extract the location information. This preserves confidentiality of location information and ensures that passive eavesdroppers on the wireless or wired networks are not able to extract sensitive location information by overhearing transmissions.

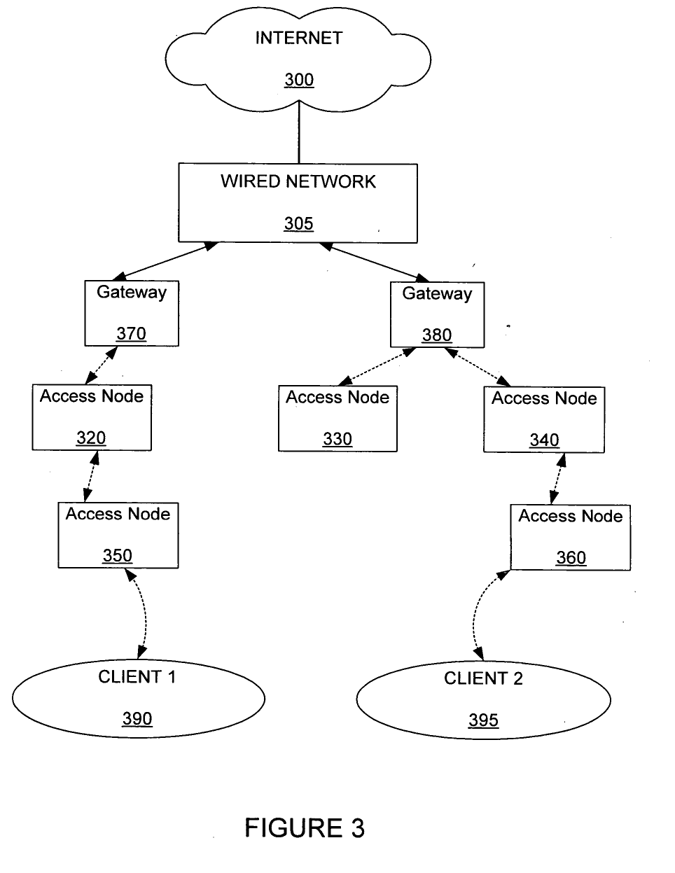

FIG. 3 shows wireless mesh network that includes access nodes 320, 330, 340, 350, 360 that provide client device location information. This network varies from the network of FIG. 1 in that this network is truly a wireless mesh network. That is, the network of FIG. 3 includes wireless access nodes 320, 330, 340, 350, 360. The access nodes of this mesh network 320, 330, 340, 350, 360 are wirelessly connected to gateways 370, 380. Other configurations can include both wired and wireless access nodes. The mesh network include first order access nodes 320, 330, 340 which are one wireless hop away from a gateway 370, 380, and second order access nodes 350, 360 which are two wireless hops away from a gateway 370, 380. The mesh network can include access nodes having any number of hops away from a gateway.

An embodiment of the mesh network includes decentralized intelligence in which the access nodes select routing paths from gateways. The routing selections are made by the access nodes themselves, and the mesh network does not need a centralized point intelligence.

The gateways 370, 380 can be wired or wirelessly connected to a wired network 350, which can be connected to the internet 300. The connection of the gateways 370, 380 to the upstream wired networks is typically a very broadband connection, and is commonly referred to as the backhaul. As just mentioned, the backhaul can be a wired or wireless connection. Examples of backhaul connections include Ethernet, fiber, coaxial cable, and wireless point-to-point or point-to-multipoint connections such as those using WiMax. Also, as mentioned, the access nodes can be any number of wireless hops away from a gateway.

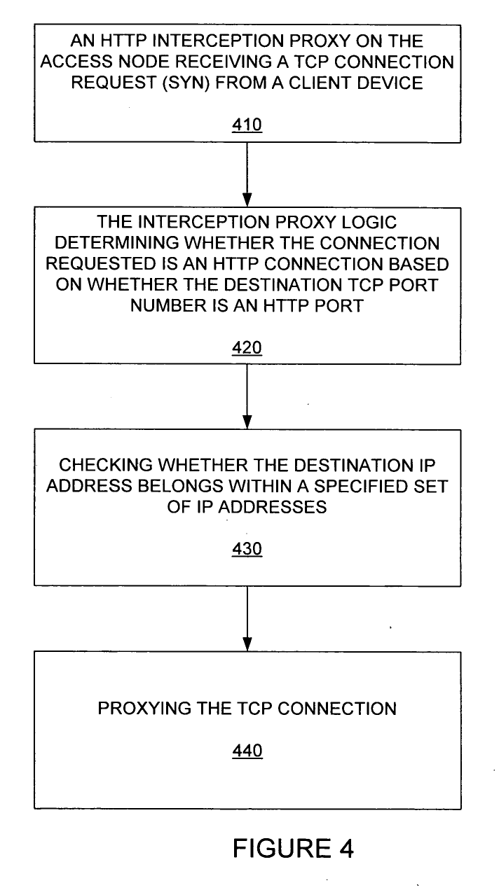

FIG. 4 is a flow chart showing a method of how an access node inserts location information into data packets of a client device. A first step 410 includes an HTTP interception proxy on the access node receiving a TCP connection request (SYN) from a client device. A second step 420 includes the interception proxy logic determining whether the connection requested is an HTTP connection based on whether the destination TCP port number is an HTTP port. In one embodiment, the connection requested is identified as an HTTP connection if the destination TCP port number is 80. If the packet is not an HTTP packet, the packet is directed to forwarding logic of the access node. If the connection requested is an HTTP connection, then a third step 430 is executed that includes checking whether the destination IP address belongs within a specified set of IP addresses. If the destination IP address does not match one of the IP addresses in the specified list, then the TCP SYN packet is directed to the forwarding logic of the access node and the connection is passed through the access node without being intercepted and proxied. If the destination IP address of the TCP SYN packet does match one of the list of specified IP addressed, then a fourth step 440 is executed that includes proxying the TCP connection. During the proxying of the connection, the interception proxy further modifies the URL requested by the client device or browser by inserting location information of the access node into the HTTP packet as location tags that are sent along with the HTTP Request to the destination server.

There are multiple ways for the specified list of IP addresses to be generated on an access node. In one embodiment, a list of IP addresses is provisioned on the access node through a network management system or through configuration variables being set on the access node through a configuration interface. Multiple protocols and mechanisms including SNMP exist for provisioning parameters on networked devices and will be known to those skilled in the art. In one embodiment, one or more domain names (such as search.provider.com) may be provisioned on the access node instead and the access node can generate the specified list of IP addresses by resolving the domain name to one or more IP addresses through the use of DNS (Domain Name System) queries. In another embodiment, the access node may snoop DNS queries and responses for the specified list of domain names and use the snooped information to generate the specified list of IP addresses.

Inspecting each and every packet that passes through an access node may impose a processing burden on the access node. Deep packet inspection (inspecting the payload of the packet as opposed to just the Medium Access Control (MAC) and Internet Protocol (IP) headers) may also impose significant processing burdens on the access node. Furthermore, proxying HTTP requests may also impose a processing burden on the access node. Finally, the network operator or provider may only want to have location tags embedded in requests sent to specific search or content providers. For these reasons it is advantageous to minimize the packet inspection logic where possible by restricting the inspection to HTTP packets on port 80 and by further restricting the set of URLs requested or destination domains or IP addresses for which the access node will proxy HTTP requests and embed location tags. An aspect of this invention is a selective interception proxy that only proxies HTTP transactions between a client and web servers within a specified set of domains (e.g., searchprovider.com) or IP addresses.

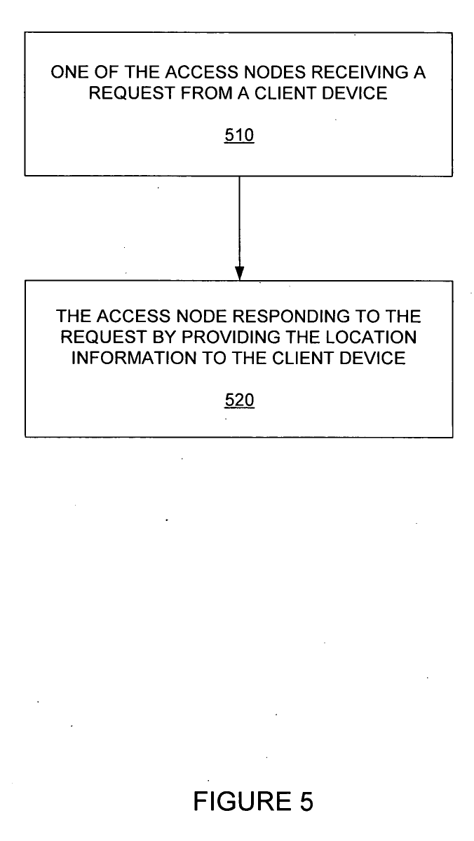

An alternate embodiment includes the client devices requesting their location information, and the access node conveying its location information to the client devices. FIG. 5 is a flow chart showing steps of a method in which access nodes provide location information to the client devices. As with previous embodiments, the access nodes have their own location information. A first step 510 of the method includes one of the access nodes receiving a request from a client device. A second step 520 includes the access node responding to the request by providing the location information to the client device.

An access node may have a web server that is capable of receiving HTTP Requests and responding to them. In one embodiment, HTTP is the protocol used by the client to request location information from the node and the protocol used by the access node to communicate location information to the client. Other protocols such as SOAP may also be used for the client device to request location information and for the access node to respond by communicating location information to the client device, as would be apparent to one. skilled in the art.

A client device with software logic on it capable of generating such requests and receiving the responses would be able to have access to its approximate location information, even if the client device does not have GPS or other location technology embedded within it. This is advantageous to the client device and enables location-aware applications and programs running on the client device without requiring the client device to have any location technology embedded within it. In addition, the client having access to the location information would be capable of embedding the location information directly in the search request, thereby making it unnecessary for an access node to function as an interception proxy and embed location tags in HTTP Requests.

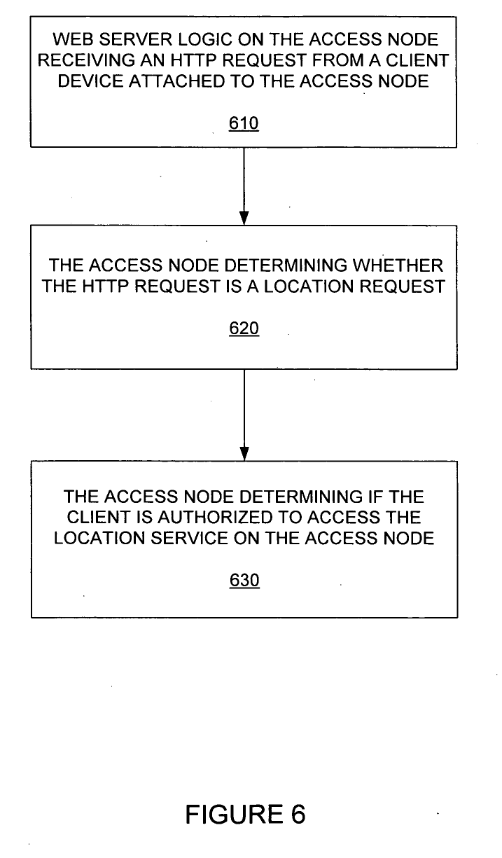

FIG. 6 is a flow chart including steps of a method of an access node responding to a client device request for location information. A first step 610 includes web server logic on the access node receiving an HTTP Request from a client device attached to the access node. A second step 620 includes the access node determining whether the HTTP Request is a location request. A third step 630 includes the access node determining if the client is authorized to access the location service on the access node. In one embodiment, this is accomplished through an authentication key embedded within the HTTP Request. Other means of determining if the client is authorized to access the location service on the access node are apparent to those skilled in the art. If the HTTP Request is a location request, then the access node generates an HTTP response that contains the access node location information.

While the flowchart outlines the logic in an example where HTTP is the protocol used by the client and the Access Node to query and respond with location information, other protocols can also be used for this purpose, as will be apparent to those skilled in the art.

Although specific embodiments of the invention have been described and illustrated, the invention is not to be limited to the specific forms or arrangements of parts so described and illustrated. The invention is limited only by the appended claims.

What is claimed:

1. A method of providing location information in a wireless mesh access network, the wireless mesh network comprising one or more mesh access nodes that have access to their location information, and providing connectivity between a client device and a destination server, the method comprising:
an access node intercepting an HTTP request from the client device;
the access node inserting at least one location tag carrying the location information into the HTTP request, and
the access node proxying the HTTP request with the at least one location tag to the destination server.

2. The method of claim 1 wherein the access node further relays an HTTP response from the destination server to the client device.

3. The method of claim 1 wherein the client device is located in a neighborhood of the access node.

4. The method of claim 1 wherein the HTTP requests that are tagged are HTTP requests to a configured set of domains.

5. The method of claim 1 wherein the HTTP requests that are tagged are HTTP requests to a configured set of IP addresses.

6. The method of claim 1 wherein the location tag is inserted in the HTTP request through a CGI variable.

7. The method of claim 1 wherein the location tag is encrypted using public key cryptography.

8. The method of claim 1 wherein location information comprises at least one of the latitude, longitude and a street address or street intersection identifier of the access node, the zip code and the city in which the access node is located.

9. The method of claim 1 wherein access nodes are configured with their location information.

10. The method of claim 1 wherein access nodes obtain their location information through the use of geo-positioning technology.

11. The method of claim 1 wherein the access node is at least one wireless hop from a point of wired backhaul.

12. A method of providing location information in a wireless mesh access network, the wireless mesh network comprising one or more mesh access nodes, and providing connectivity between a client device and a destination server, the method comprising:
each access nodes having its own location information;
one of the access nodes receiving a request from a client device; and
the access node responding to the request by providing the location information to the client device.

13. The method of claim 12 wherein the request from the client device is an HTTP request.

14. The method of claim 12 wherein the response from the access node is an HTTP response.

15. The method of claim 12 wherein the location information is encrypted.

16. The method of claim 12 wherein the client device is located in the neighborhood of the access node.

17. The method of claim 12 wherein location information comprises at least one of the latitude, longitude and a street address or street intersection identifier of the access node, the zip code and the city in which the access node is located.

18. The method of claim 12 wherein access nodes are configured with their location information.

19. The method of claim 12 wherein access nodes obtain their location information through the use of geo-positioning technology.

20. The method of claim 12 wherein the access node is at least one wireless hop from a point of wired backhaul.
